(19) United States
(12) Patent Application Publication
(10) Pub. No.: US 2022/0259356 A1
(43) Pub. Date: Aug. 18, 2022

(54) TRACEABLE COMPOSITE POLYMERS AND PREPARATION METHODS THEREOF FOR PROVIDING TRANSPARENCY IN PRODUCTION VALUE CHAINS

(71) Applicant: SECURITY MATTERS LTD., D.N. Revel Eilot (IL)

(72) Inventors: Tehila NAHUM, Holon (IL); Michal FIRSTENBERG, Rehovot (IL); Hagit SADE, Ramat Gan (IL); Nataly TAL, Nes Ziona (IL); Haggai ALON, Kibbutz Naan (IL); Nadav YORAN, Tel Aviv (IL)

(21) Appl. No.: 17/626,923

(22) PCT Filed: Jul. 15, 2020
(86) PCT No.: PCT/IL2020/050793

§ 371 Date: Jan. 13, 2022

Related U.S. Application Data
(60) Provisional application No. 62/874,141, filed on Jul. 15, 2019.

(51) Int. Cl. C08F 255/02; C08F 265/04

(52) U.S. Cl. CPC C08F 255/02; C08F 265/04

(57) ABSTRACT

The present invention is in the field of polymers comprising identifiable tracers by spectroscopic methods such as XRF, IR, NIR and XRD allowing information to be encoded by the polymers, and in particular polymers for conservation, restoration and retouching in artworks, electronics, coatings, plastics, packaging, 3D printing, rubber, and the like.

### FIELD OF THE INVENTION

The present invention is in the field of polymers comprising identifiable tracers by spectroscopic methods such as XRF, IR, NIR and XRD allowing information to be encoded by the polymers, and in particular polymers for conservation, restoration and retouching in artworks, electronics, coatings, plastics, packaging, 3D printing, rubber, and the like.

### BACKGROUND

US Patent Application No. 2005/0119373 [1] discloses metal acrylate compounds, such as zinc diacrylate (ZDA) and zinc dimethacrylate (ZDMA), for curing epoxy functionalities and other cross-linking compounds, and compositions containing such compounds for use in powder coat, film, adhesive, among other applications, which can cure the epoxy component of the compositions while being substantially free of conventional curing agents.

### PUBLICATIONS

US Patent Application No. 2005/0119373.

### GENERAL DESCRIPTION

The inventors of the technology disclosed herein have realized that for the purpose of authenticating objects of various materials, the objects may be coated or marked or appended with a transparent polymeric material that comprises tracer atoms detectable by XRF. As the presence of an even minute amount of tracer atoms in a polymeric material was found to have an effect on certain properties of the material, e.g., its transparency, consistency, mechanical properties and the ability to form a homogenous material, the use of polymers as a medium for XRF tracers was limited to particular class of polymers, specific selections of tracer atoms or to specific tracer amounts.

The present invention concerns polymeric materials comprising one or more XRF-detectable tracers that are homogenously distributed in the material and are provided in a form that maintains the ability to detect, measure and record the presence of the one or more tracer elements. The tracer elements present or contained in the polymeric material, as disclosed herein, are stable, do not exhibit any leaching out or migration, and do not cause polymer blooming. In fact, inclusion of the elements in the polymers of the invention does not modulate or alter the properties of the polymeric material that comprises them. As such, polymers of the invention have also been tested as additives to industrial polymeric master batches of compositions, endowing such batches or compositions with XRF marking capabilities.

In a first aspect, the invention provides a composition comprising a modified polymer having one or more functionalities associated with at least one XRF-detectable metal ion and one or more reactive functionalities.

Further provided is a composite of a modified polymer having one or more functionalities associated with at least one XRF-detectable metal ion and one or more reactive functionalities.

The polymeric composite may be prepared from a combination of at least one polymeric material (a polymer or a pre-polymer, a monomer or an oligomer thereof) with at least one polymerizable metal salt or polymerizable metal complex, as defined, under conditions permitting association/conjugation/polymerization of the at least one polymerizable salt or complex to the backbone of the polymeric material or to any pendant group present on the polymer backbone.

Thus, the invention further provides a composition comprising a blend of at least one polymeric material (or a prepolymer or a monomer or an oligomer of the polymeric material) and at least one XRF-detectable tracer in a form of polymerizable metal salt or a polymerizable metal complex, wherein the polymerizable metal salt or polymerizable metal complex comprises at least one metal ion (namely a metal cation) and at least one polymerizable organic anion.

In some embodiments, the composition may comprise at least one other polymeric material, e.g., the so-called bridging polymer mentioned below.

As used herein, the at least one “polymeric material” is a polymer of any constitution, molecular weight and conjugation that comprises one or more functionalities capable of undergoing chemical association with at least one polymerizable monomer, namely with at least one of the polymerizable metal salt or metal complex. The polymer may be selected from any polymer known in the art. The polymer may be synthetic, semi-synthetic, or natural. It may be modified to adopt one or more functionalities that can associate, as described, with a metal ion and/or one or more functionalities that can undergo polymerization with a polymerizable monomer. A polymeric material having undergone modification or polymerization with one or more of the polymerizable metal salt or metal complex is referred to herein as the “modified polymer”.

In some embodiments, the polymeric material may be selected from organic polymers and inorganic polymers. In some embodiments, the polymeric material is a conductive polymer.

The polymeric material may be selected from fluoropolymers, phenolic resins, polyanhydrides, polyketones, polyesters, polyolefins, vinyl polymers, acrylics, polybenzimidazole, polycarbonate, polystyrene, polyvinyl chloride, and others.

In some embodiments, the polymeric material is selected from polystyrenes, e.g., acrylonitrile butadiene styrene; polycarbonates; polyamides; polyacrylates, e.g., polymethacrylates; polyurethanes; epoxy polymers and others.

In some embodiments, the polymeric material is a homopolymer or a copolymer that are based on acrylic acid. These may include poly(acrylic acid) homopolymer, poly(acrylic acid-co-itaconic acid) and poly(acrylic acid-co-maleic acid) copolymers.

In some embodiments, the polymeric material is a poly acrylate or derived from polyacrylic acid (PAA).

In some embodiments, the polymeric material is a homopolymer or a copolymer that are based on acrylic acid. These may include poly(acrylic acid) homopolymer, poly(acrylic acid-co-itaconic acid) and poly(acrylic acid-co-maleic acid) copolymers.

In some embodiments, the polymeric material is Paraloid B-72, having the structure:

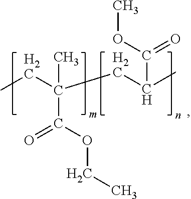

where m:n ratio is 70:30.

The polymeric material may be presented in a composition of the invention in a form that is capable of undergoing polymerization into a desired modified polymer. The polymeric material may be in a form selected from a pre-polymer, a monomer, an oligomer or a short polymer form that can be polymerized, condensed, nucleophilically substituted or conjugated to form the modified polymer used in accordance with the invention.

The “polymerizable metal salt” and “polymerizable metal complex” are two alternative forms of a metal ion when in association with a polymerizable anionic monomer. The polymerizable metal salt or complex is generally of the form (monomer)ₙMₛ wherein n is the number of monomer (or anionic functionalities) units that are associated to the metal atom M, and s is the number of metal atoms in the salt or complex. For example, in a polymerizable aluminum salt, the salt or complex may be in the form of (monomer)ₙMₛ, wherein n is 3, M is Al and s is 1. Thus, in a polymerizable metal salt or complex of the form (monomer)ₙMₛ, the monomer is a polymerizable material, as defined herein, n may be between 1 and 5, M is a metal in a positively charged form capable of associating between 1 and 5 ligand groups (or polymerizable monomers), and s is between 1 and 3.

The monomer used in a polymerizable form of the metal, is any monomer that is capable of undergoing crosslinking or conjugation or grafting to a functionality on the polymer backbone, as defined, and which comprises an atom, typically a heteroatom selected, for example, from N, O and S, that is in a charged form or that is capable of forming a coordination bond with the metal atom. The number of monomers that are associated to the metal atom depend on the specific metal atom. For example, where the monomer is an acrylate, a polymerizable metal ion may comprise two acrylate units in cases where the metal is bivalent or three acrylate units in cases the metal is trivalent, or may simply comprise a single acrylate where the metal is monovalent.

In a polymerizable metal ion or complex the monomers may or may not be the same. In polymerizable metal ions or complexes comprising two or more monomers, each of the monomers may be the same or different. Also, a composition of the invention may comprise a mixture of two or more different types of polymerizable metal ions or complexes.

The monomer may be selected from such materials having a functionality selected from amines, hydroxyls, carboxylic acids, thiols, and others. In some embodiments, the monomer is selected amongst hydroxylated monomers. In some embodiments, the monomer is selected amongst amine monomers or amide monomers.

In some embodiments, the monomer is selected from acrylate, alkyl acrylates, substituted alkyl acrylates, acrylamide, adipate, substituted adipates, itaconate, and others.

In some embodiments, the monomer is acrylate or an alkyl acrylate. The alkyl acrylate may be selected from methylacrylate, ethylacrylate, propylacrylate, butylacrylate and others.

In some embodiments, the acrylate monomers are selected from acrylate, butylacrylate, methylacrylate, methacrylate and others.

The tracer atoms present in the form of a metal ion in a polymerizable metal ion or complex are selected amongst XRF-detectable tracer atoms. Such atoms may be selected from Na, K, Ba, Ca, Mg, Ni, Al, Cr, Co, Cu, Hf, Fe, Pb, Sn, Zn, Ti, Zr, Y, Se, Nb, Sr, Mn, Mo, V, Bi and others.

In some embodiments, the monomer is an acrylate or an alkyl acrylate, as selected herein, and the XRF-detectable tracer or ion is any one or more of Na, K, B a, Ca, Mg, Ni, Al, Cr, Co, Cu, Hf, Fe, Pb, Sn, Zn, Ti, Zr, Y, Se, Nb, Sr, Mn, Mo, V and Bi. In some embodiments, the polymerizable metal ion is a metal acrylate, wherein the metal is any one or more of the herein listed metals and the acrylate is derived from acrylic acid, alkyl acrylic acid or any substituted form thereof.

In some embodiments, the polymerizable metal ion is selected from aluminum acrylate, aluminum methacrylate, barium acrylate, calcium acrylate, chromium(II) acrylate, cobalt acrylate, copper(II) acrylate, hafnium carboxyethyl acrylate, iron(III) acrylate, lead(II) acrylate, lead(II) methacrylate, magnesium acrylate, nickel acrylate, potassium acrylate hydrate, sodium methacrylate, tin(II) acrylate, zinc acrylate, zinc methacrylate, zirconium acrylate, zirconium methacrylate, zirconium carboxyethyl acrylate, zirconium(IV) oxo hydroxy methacrylate, and others.

A composition of the invention comprising the polymeric material and the at least one polymerizable metal ion or metal complex may be transformed into a polymeric composite in a form of a crosslinked or conjugated modified polymer incorporating a plurality of ionically or coordinatively associated metal ions. The composite may be of a variety of forms. The transformation into the modified polymer or composite material may be achieved in the presence of at least one initiator or a catalyst, under thermal conditions, under vacuum, under pressure or under light irradiation conditions, or may spontaneously occur. Covalent association between the monomers and functionalities on the polymeric backbone may follow any one or more processes known in the art. Such may include free-radical reactions, ionic reactions, condensation reactions, addition reactions, substitution reactions, coordination assembling, transesterification and others.

The polymeric composite thus formed comprises a modified polymer that is associated with a plurality of functionalities in ionic or coordination association with at least one metal ion. The composite material may be used as the bulk material of various polymeric products or as polymeric coatings and thus may be produced in a mold or in an extrusion process or may be formed as a coat or a film on a surface region of various products and substrates.

The composite may be formed into granules or into any other solid form suitable as raw material. In addition, the composite may be formed as a master batch.

As known in the art, a masterbatch, also referred to as a concentrate, is a package for improving properties of plastics. Various additives are dispersed at high concentration into a polymer carrier which is extruded and pelletized. Addition of an XRF detectable polymer of the invention into a polymeric (plastic) composition improves composition properties by allowing full traceability along the value chain, better sorting of different plastics, enhance recyclable quality and full plastics circularity. The master batch may be provided in the form of pellets or as a flowable composition.

The modified polymer is further substituted or functionalized. As stated herein, a modified polymer having one or more functionalities associated with at least one XRF-detectable metal ion may be additionally characterized by one or more or a plurality of reactive functionalities. While the majority of the functionalities on a polymeric material, as defined, are generally functionalized to associate the XRF-detectable metal ions, some of the functionalities may remain reactive, namely capable of undergoing functionalization, substitution or otherwise chemical coupling with another moiety. In some embodiments, where the polymeric material comprises a plurality of different functionalities of different reactivities, functionalization of the polymeric material, as explained herein, may be tailored to yield a degree of functionalization that is less then 100%.

In some embodiments, a modified polymer according to the invention comprises between 1 and 10% of reactive functionalities, which are mainly positioned at the polymer termini In some embodiments, the number of reactive functionalities is between 2 and 5% of the total number of modified functionalities present on the modified polymer.

The reactive functionalities may be selected amongst amines, hydroxyl groups, aldehyde groups, carboxylic acid groups, amide groups, thiol groups, thio carboxylic acid groups, and others.

Notwithstanding the above, the existence of reactive functionalities on a modified polymer may be used to further functionalize the modified polymer. In some embodiments, further functionalization of a modified polymer according to the invention comprises functionalization of the reactive functionalities with a functionalized polymer or a functionalized material. Following such a functionalization, the modified polymer is substituted to a polymer or a material resulting in a bridged polymer characterized by any one or more of: a higher molecular weight, increased or decreased hydrophobicity, increased or decreased hydrophilicity, a self-organized material having a form derived from the polymer or material substituted on the modified polymer, or a functionalized material which function is derived from the nature of the substituting polymer or material.

In some embodiments, the bridged polymer is a product of a reaction between a modified polymer and a polymer selected from thermoplastic polymers, elastomers, polyolefines, plastics, rubber, and others. Non-limiting examples of such polymers include polyethylene glycol, polyethylene, polypropylene, acrylonitrile butadiene styrene (ABS), polystyrene, high impact polystyrene, polycarbonate, rubber and others. The association between the modified polymer and the bridging polymer may be direct, namely by reacting a functional group on the polymer and a reactive moiety on the modified polymer; or indirect through the use of a linker moiety such as a diol, diamine, an anhydride, an activated carbonyl group and others.

The invention thus provides a polymer comprising one or more functionalities associated with at least one XRF-detectable metal ion and one or more polymeric moieties extending therefrom. In other words, the polymer of the invention comprises a modified polymer, as defined, and is grafted with at least one additional polymer

In some embodiments, the one or more polymeric moieties extending from the polymer or that are grafted on the polymer is selected from polyethylenes, polypropylenes, polyethylene glycols, polyamides, polyalcohols, and others.

Composites may also be made of such polymers of the invention.

In some embodiments, the composites or polymers of the invention are selected from maleic anhydride grafted polypropylene (-MAH-g-PP) polymers such as PAA450NaY-MAH-g-PP, PAA450NaZr-MAH-g-PP, PAA450NaMo-MAH-g-PP, PAA450KY-MAH-g-PP, PAA450KZr-MAH-g-PP, PAA450KMo-MAH-g-PP, PAA6NaY-MAH-g-PP, PAA6NaZr-MAH-g-PP, PAA6NaMo-MAH-g-PP, and others.

In most general terms, composites and polymers of the invention may be utilized in a vast gamut of applications. Such include industrial applications, medicinal applications, agricultural applications, water-based technologies and others. Composites and polymers may be used as packaging materials, as films, as surfaces, as containers, as well as additives into other composites and combinations. Depending on the nature of, inter alia, the polymer used, the traceable ion, the presence or absence of a bridging material or polymer and the nature of such material or polymer, and the characteristics and properties stemming from the selection of such materials in the construction of the polymer or composite, the polymers and composites of the invention may further be used as functional materials. By using such materials in the fabrication of objects or adding such materials to compositions, functionality may be endowed. Such a functionality may be selected from hydrophobicity, hydrophilicity, self-cleaning, antifouling, reflectivity, absorptivity and others. As products of the invention, including the modified polymers and composites include one or more XRF-tracers, such functional products may be identified.

In accordance with the invention disclosed herein, the tracers may be detected and their concentration measured by directing a primary electromagnetic signal to the polymeric material and detecting and analyzing a (secondary) response signal from the polymeric material. In particular, the tracers may be measured by using XRF analysis; namely by directing an X-ray (or Gamma-ray) signal toward the polymeric material and measuring an X-ray response signal. In an example, the tracers may be detected by Energy Dispersive X-Ray Fluorescence (EDXRF) analysis, using an EDXRF analyzer. In a particular example, the EDXRF analyzer may be a mobile or a handheld device. In another example the tracers are detected and using a Wavelength Dispersive X-Ray Fluorescence (WDXRF) analyzer.

Alternatively or additionally the presence of tracers in the composite of the present invention may be detected by IR or NIR spectroscopy due to the new ionic bond between the carboxylic group and the metal atom in the ionomer.

In yet another aspect of the present invention, the presence of the tracers may be detected by X-Ray Diffraction (XRD) spectroscopy.

Since the tracers may be included in varying concentrations in the modified polymers or composite materials, which can be measured, the modified polymers, composites and products of the invention may be encoded with information. Products made from composites and polymers or the substrate to which these may be applied to (e.g. by coating), may include information which may be used in track and trace methods, authentication and verification methods, supply chain and logistical management, quality control, process control, and for a variety of other applications. The tracers included in the traceable polymeric material of the present invention may be detected and measured in minute concentrations, for example by employing reading methods described for example in International Patent Application PCT/IL2016/050340 or any US application derived therefrom, which is incorporated herein by reference.

In an aspect of the invention, composites of the present invention may also be blended with additional tracers (e.g., XRF identifiable tracers), increasing the number of overall tracers in the polymeric composite and consequently the amount of information that can encoded by the system.

The tracers incorporated with the composite of the present invention are chemically bonded/chemically associated to the traceable polymer backbone. In other words, the tracers are bonded to atoms or atom groups which are directly bonded to the polymer backbone. Such a system of traceable polymers is inherently stable and does not exhibit instability and incompatibility that may occur in blended systems, wherein tracers are blended with a polymeric system. Furthermore, such a system of traceable polymers does not undergo migration, blooming, and/or leaching. Such properties may be significant in objects which may be in contact with consumable products (e.g. food, pharmaceutical). For example, plastic products described in International patent application PCT/IL2017/051112 or any US application derived therefrom, which are incorporated herein by reference.

According to another aspect of the invention, the composites of the present inventions may be used for 3D printing enabling the authentication and verification of origin of the material. In some embodiments, the composite or polymer is an additive in an ink formulation or in a formulation used for printing.

In a further aspect of the invention, the composites may be used in the plastic industry for marking and tracing packages, and in particular packages for food product and medical products, wherein the structure of the composites prevents migration of materials (e.g. tracers and marking materials) into the packed product. The packages may be formed of any material into which a polymer or composite of the invention may be added.

The composites of the present invention may also be used for marking and tracing textile products or electronic products as well as materials such as epoxy (e.g. for use in cements), PVC, TPU. In such applications, the polymer or composite of the invention may be used as a material in the production of the textile or electronic product or as a marker that is associated therewith.

In other aspects, the composites of the present invention may be used in ink and dyes (e.g. for authenticating security documents) and adhesives.

In yet another aspect of the invention, the composites may be used in rubber products (e.g. tires, conveyor belts).

In an exemplary system of the invention, a traceable polymer was used for conservation, restoration, and retouching of artworks. The polymer being copolymer PARALOID™ B-72 is an acryloid polymer that is a durable and non-yellowing acrylic resin, in the form of an ethyl-methacrylate copolymer. In addition to applications such as restoration and conservation, copolymer B72 was used also as a platform for tagging paintings and artworks in general. The modified B72 of the present invention provides a built-in tagging and tracing capability together with the properties of the original copolymer B72. Other polymeric systems have been prepared and used as disclosed herein.

Thus, the invention further provides a method of marking an object to be authenticated, the method comprising forming a film or a mark on at least a region of said object, said mark being in the form of a composite material of the invention.

The invention further provides a method of authenticating an object having been marked with a composite material of the invention, the method comprising directing a primary electromagnetic signal to the material and detecting and analyzing a (secondary) response signal from the material.

In some embodiments, the method comprises directing an X-ray (or Gamma-ray) signal in the direction of the material and measuring an X-ray response signal.

Thus, the invention provides the following embodiments of the invention:

A polymer having one or more functionalities associated with at least one XRF-detectable metal ion, the polymer being grafted with at least one additional polymer.

In some embodiments, the polymer is selected from fluoropolymers, phenolic resins, polyanhydrides, polyketones, polyesters, polyolefins, vinyl polymers, acrylics, polybenzimidazole, polycarbonate, polystyrene and polyvinyl chloride.

In some embodiments, the polymer is selected from polystyrenes; polycarbonates; polyamides; polyacrylates; polyurethanes; and epoxy polymers.

In some embodiments, the one or more functionality is an acrylate.

In some embodiments, the one or more functionality is selected from an amine, a hydroxyl, a carboxylic acid and a thiol.

In some embodiments, the metal ion is selected from Na, K, Ba, Ca, Mg, Ni, Al, Cr, Co, Cu, Hf, Fe, Pb, Sn, Zn, Ti, Zr, Y, Se, Nb, Sr, Mn, Mo, V Bi and La.

In some embodiments, the at least one additional polymer is selected from thermoplastic polymers, elastomers, polyolefines, plastics, and rubber.

In some embodiments, the at least one additional polymer is selected from polyethylene glycol, polyethylene, polypropylene, acrylonitrile butadiene styrene (ABS), polystyrene, high impact polystyrene, polycarbonate and rubber.

In some embodiments, the polymer is selected from maleic anhydride grafted polypropylene (-MAH-g-PP) polymers.

In some embodiments, the polymer is selected from PAA450NaY-MAH-g-PP, PAA450NaZr-MAH-g-PP, PAA450NaMo-MAH-g-PP, PAA450KY-MAH-g-PP, PAA450KZr-MAH-g-PP, PAA450KMo-MAH-g-PP, PAA6NaY-MAH-g-PP, PAA6NaZr-MAH-g-PP and PAA6NaMo-MAH-g-PP.

A composition is provided that comprises a polymer according to the invention. The may be a master batch, and/or may be in a form of a pellet.

A composite is also provided that comprises a polymer according to the invention.

A method of marking an object to be authenticated is provided that comprised forming a film or a mark on at least a region of said object, said mark being in the form of a composite of the invention.

A method of authenticating an object having been marked with a composite material of the invention is provided that comprised directing a primary electromagnetic signal to the material and detecting and analyzing a (secondary) response signal from the material.

In some embodiments, the method comprising directing an X-ray signal in the direction of the material and measuring an X-ray response signal.

An object is provided that comprised a polymer according to the invention. In some embodiments, the object is a packaging material, a textile, an electronic object, an ink composition, a master batch or a rubber-based product.

Also provided is a packaging material comprising a polymer of the invention. The packaging material may be of a food product or a medical product or any other product or object as known in the art.

### DETAILED DESCRIPTION OF EMBODIMENTS

### Methods of Preparation

Methods of preparing the polymeric composite material of the present invention (described below) include reaction between polymers and tracer carrying monomers (for example, metal modified monomers). By using both polymers and monomers one may easily obtain the traceable polymeric composite material of the present invention essentially having the main properties of the parent polymer. For example, one may use the B72 polymer as the parent polymer and obtain a traceable or a code-carrying modified B72 polymer which keeps the basic properties of original B72 polymer (e.g. adhesiveness, transparency, flexibility, solvability, etc). Furthermore, by controlling the reaction of the parent B72 with the tracer carrying monomers (e.g. by controlling concentration of the monomers or other agents used in the process and/or the conditions of the process), the resulting modified B72 may enhance or suppress some of the original properties according the required application. For instance, one may use the modified B72 for anti-counterfeit and authentication-verification purposes wherein the modified B72 may be less solvable the parent B72.

### (i) Wet Chemistry

The traceable composite polymer of the present invention may be formed by using tracer carrying monomer and a parent polymer dissolved in a solvent, in the presence of a radical initiator.

### (ii) Reactive Extrusion

The traceable composite polymer of the present invention may be prepared by using a reactive extruder wherein polymerization is achieved without the use of solvents.

### Polymeric Compositions of the Invention

Compositions of the invention were prepared using any one of the polymers listed in Table 1 below. In the Table, M is Nb, Mo, Y or Zr derived from salts such as from NbCl₅, MoCl₅, YCl₃, NbCl₅ (used as hydrate molecules).

TABLE 1

| | |
|---|---|
| PAA450 | Polyacrylic acid powder with a Mw = 450 K |
| PAA450Na | Sodium modified polyacrylic acid powder with a |
| | Mw = 450 K |
| PAA450K | Potassium modified polyacrylic acid powder |
| | with a Mw = 450 K |
| PAA450NaM | PAA450Na complexed with a heavy metal |
| PAA450KM | PAA450K complexed with a heavy metal |
| PAA6Na | Polyacrylic sodium salt powder with a Mw = |
| | 6 K (used as reference) |
| PAA6NaM | Polyacrylic sodium salt powder with a Mw = |
| | 6 K complexed with a heavy metal (used as reference) |

### Preparation of Sodium/Potassium Salt PAA450

Option A: in DI-Water

10 g PAA450 were mixed with dilute NaOH (0.05N) until the solution became alkaline and kept for 24 h. The functionalized polymer was collected by filtration, washed with water to remove excess NaOH and dried in vacuum.

10 g PAA450 were mixed with dilute KOH (0.05N) until the solution became alkaline and kept for 24 h. The functionalized polymer was collected by filtration, washed with water to remove excess NaOH and dried in vacuum.

Option B: in Ethanol

5.1 g of KOH/NaOH were added into 100 ml ethyl alcohol (purity 95%) in a glass bottle and mechanically stirred to reach full dissolution. Then, 10 g of PAA450 were added into the solution with constant stirring for 9 hours at room temperature. After 9 hours of mixing, the product was filtrated and washed with water to remove excess of KOH/NaOH and dried at 50° C. overnight.

Option C: in Iso Propyl Alcohol (IPA)/DI-Water (95:5) Mixture

As ethanol is known to have negative environmental effects, IPA was used as an alternative. However, since PAA is not soluble in IPA, different IPA:water compositions were tested to dissolve both PAA and KOH/NaOH. 95:5 wt % IPA: water was found to dissolve PAA and KOH, but not NaOH.

Thus, 5.1 g of KOH were added into 100 ml IPA/water solution in a glass bottle and mechanically stirred to reach full dissolution. Then, 10 g of PAA450 were slowly added into the KOH solution with constant stirring until full dissolution. The solution was stirred for 9 hours at room temperature. The product was allowed to sit for 24 hrs under to hood, for IPA/water evaporation, then 100 cc DI-water were added to remove excess unreacted KOH. The product was then dried in an oven at 50° C. overnight.

### Complexation with Metal Ions

Metal salts, such as metal chlorides were used for their water solubility (YCl₃, MoCL₅, ZrOCl₂).

100 mg PAA6Na were stirred with a definite excess concentration of metal salt solution under natural pH (0.05 N, 50 ml) for 9 h. The product (PAA6NaM) was collected by filtration and washed with excess distilled water to remove un-complexed metal ions.

100 mg PAA450Na was stirred with a definite excess concentration of metal salt solution at its natural pH (0.05 N, 50 ml) for 9 h. The product (PAA450NaM) was collected by filtration and washed with excess distilled water to remove un-complexed metal ions.

100 mg PAA450K was stirred with a definite excess concentration of metal salt solution at its natural pH (0.05 N, 50 ml) for 9 h. The product (PAA450KM) was collected by filtration and washed with excess distilled water to remove un-complexed metal ions.

All the above experiments were repeated at different pH values (ranging from 3 to about 6-7).

In the IR spectrum of the PAA450, asymmetric (C—O)₂ stretching of the carboxylate group COOH absorbed strongly near 1698 cm⁻¹. On the contrary, PAA450Na exhibited a small absorption near 1698 cm⁻¹ indicating presence of a small amount of COOH groups. A new asymmetric (C—O)₂ stretching peak with high absorption was observed near 1539 cm⁻¹, indicating new COONa bonds. Upon coordination with the metal Y, the (C—O)₂ stretching frequency was shifted down from 1539 cm⁻¹, for COONa, to 1531 cm⁻¹, indicating complexation with metal Y ions (COOY bond). To calculate the reaction yield, the following equation was used:

$$complexation \% = \frac{{( {A}_{COOH} / {A}_{C - H} )}_{P A A 450} - {( {A}_{COOH} / {A}_{C - H} )}_{P A A 450 M}}{{( {A}_{COOH} / {A}_{C - H} )}_{P A A 450}}$$

As shown in Table 2 below, PAA450Na exhibited a high complexation yield, suggesting that the majority of COOH groups reacted with Na. PAANaY also showed a similar complexation yield, suggesting a small number of COOH groups and that the majority of COO groups are bonded to metal ion Na or Y.

TABLE 2

| | A_{C-H} | A_{COOH} | % complexation |
|---|---|---|---|
| PAA450 | 0.411 | 1.605 | 0% |
| PAA450Na | 4.91 | 1.835 | 90.42% |
| PAA450NaY | 0.306 | 0.025 | 97.9% |

TGA Results

Thermogravimetry analysis of the polymer-metal complexes described above was used to reveal variation of thermal stability by complexation with metal ions (creation of COOM bonds). Generally, the thermal decomposition behavior of a polymer-metal complex depends on the macromolecular characteristics of the polymer support and the type of coordination geometry. Un-complexed PAA (comprising only COOH) was shown to undergo multiple decomposition steps with increasing temperatures:

Step A: Evaporation of absorbed water molecules;

Step B: Release of water from intramolecular anhydride formation due to heating;

Step C: Release of water from intermolecular anhydride formation due to heating;

Step D: Decarboxylation and decomposition; and

Step E: Organic burn.

All 5 decomposition steps noted for PAA450 were as expected. PAA450Na exhibited a higher weight loss at the beginning, as compared to PAA450, due to water evaporation; however, from step B to D only approximately 10% weight loss was observed as compared to PAA450 (which showed an 82% weight loss). This small decrease in weight indicated the lack of COOH groups and supported the observation that the majority of COOH groups reacted with NaOH to yield new COONa bonds with better thermal stability. From step E, PAA45Na showed a deep decrease in weight due to burning of the organic moieties of the polymer.

PAA450NaZr behaved in a similar way to PAA450, suggesting pronounced amount of carboxylic acid groups (step B to D) and supports a low degree of conversion. PAA450NaY behaved in a similar way to PAA450Na, suggesting presence of a small amount of carboxylic acid groups (step B to D), indicating a high degree of conversion. Both PAA450NaY and PAA450NaZr demonstrated smaller weight losses with increasing temperatures as compared to PAA450. This indicates an enhanced thermal stability of the new COOM (M=Zr or Y) ionomers.

Comparing PAA450NaY to PAA450NaZr, PAA450NaY exhibited smaller weight loss meaning better thermal stability. For PAA450NaY a residual of 61% inorganic (Y) content was observed at the end of test temperature of 600° C.

XRF Results

XRF readings of polymers of the invention showed that before a metal, e.g., yttrium underwent complexation, no metal was detected in PAA450 and PAA450Na. However, after complexation, the peak intensity was increased, confirming the presence of the metal, e.g., yttrium.

Condensation Reaction with MAH-g-PP or AA-g-PE

A common way of increasing the adhesion, compatibilization, wettability properties of polymers is modification with a polar polymer or low molecular weight additive such as maleic anhydride, unsaturated carboxylic derivatives and vinyl or acrylic compounds containing more than one functional group. The low molecular weight compounds can be grafted on the polymer in the melt, forming graft or block co-polymers during processing.

Maleic anhydride-grafted polypropylene (MAH-g-PP) is a compatibilizer which is very effective and commonly used for polymer matrix at the interface. It is used for improving poor interfacial adhesion between additives and PP matrix. The addition of 2.5%-5.0% of MA-g-PP to a PP composite did not affect the Tₘ value.

Condensation of PAA450 with MAH-g-PP

PAA450 and MAH-g-PP were first heated at 80° C. for 2 h and then mixed in a tremble mixer for 10 min The mixed PAA450 and MAH-g-PP were compounded by co-rotating twin screw extruder and operated temperatures for barrel zones were 160° C., 165° C., 170° C. and 175° C., and the temperature of die zone was 180° C.

Condensation of PAA450NaY with MAH-g-PP

PAA450NaY and MAH-g-PP were first heated at 80° C. for 2 h and then mixed in a tremble mixer for 10 min. The mixed PAA450NaY and MAH-g-PP were compounded by co-rotating twin screw extruder and operated temperatures for barrel zones were 160° C., 165° C., 170° C. and 175° C., and the temperature of die zone was 180° C.

Condensation of PAA450NaZr with MAH-g-PP

PAA450NaZr and MAH-g-PP were first heated at 80° C. for 2 h and then mixed in a tremble mixer for 10 min. The mixed PAA450NaZr and MAH-g-PP were compounded by co-rotating twin screw extruder and operated temperatures for barrel zones were 160° C., 165° C., 170° C. and 175° C., and the temperature of die zone was 180° C.

Condensation of PAA450NaMo with MAH-g-PP

PAA450NaMo and MAH-g-PP were first heated at 80° C. for 2 h and then mixed in a tremble mixer for 10 min. The mixed PAA450NaMo and MAH-g-PP were compounded by co-rotating twin screw extruder and operated temperatures for barrel zones were 160° C., 165° C., 170° C. and 175° C., and the temperature of die zone was 180° C.

Condensation of PAA450KY with MAH-g-PP

PAA450KY and MAH-g-PP were first heated at 80° C. for 2 h and then mixed in a tremble mixer for 10 min. The mixed PAA450KY and MAH-g-PP were compounded by co-rotating twin screw extruder and operated temperatures for barrel zones were 160° C., 165° C., 170° C. and 175° C., and the temperature of die zone was 180° C.

Condensation of PAA450KZr with MAH-g-PP

PAA450KZr and MAH-g-PP were first heated at 80° C. for 2 h and then mixed in a tremble mixer for 10 min. The mixed PAA450KZr and MAH-g-PP were compounded by co-rotating twin screw extruder and operated temperatures for barrel zones were 160° C., 165° C., 170° C. and 175° C., and the temperature of die zone was 180° C.

Condensation of PAA450KMo with MAH-g-PP

PAA450KMo and MAH-g-PP were first heated at 80° C. for 2 h and then mixed in a tremble mixer for 10 min. The mixed PAA450KMo and MAH-g-PP were compounded by co-rotating twin screw extruder and operated temperatures for barrel zones were 160° C., 165° C., 170° C. and 175° C., and the temperature of die zone was 180° C.

Condensation of PAA6NaY with MAH-g-PP

PAA6NaY and MAH-g-PP were first heated at 80° C. for 2 h and then mixed in a tremble mixer for 10 min. The mixed PAA6NaY and MAH-g-PP were compounded by co-rotating twin screw extruder and operated temperatures for barrel zones were 160° C., 165° C., 170° C. and 175° C., and the temperature of die zone was 180° C.

Condensation of PAA6NaZr with MAH-g-PP

PAA6NaZr and MAH-g-PP were first heated at 80° C. for 2 h and then mixed in a tremble mixer for 10 min. The mixed PAA6NaZr and MAH-g-PP were compounded by co-rotating twin screw extruder and operated temperatures for barrel zones were 160° C., 165° C., 170° C. and 175° C., and the temperature of die zone was 180° C.

Condensation of PAA6NaMo with MAH-g-PP

PAA6NaMo and MAH-g-PP were first heated at 80° C. for 2 h and then mixed in a tremble mixer for 10 min The mixed PAA6NaMo and MAH-g-PP were compounded by co-rotating twin screw extruder and operated temperatures for barrel zones were 160° C., 165° C., 170° C. and 175° C., and the temperature of die zone was 180° C.

Compatibility of the immiscible blend components can be greatly improved using peroxides, taking advantage of high reactivity of polyolefins to free radical that good starting point for promoting compatibilization between polypropylene or polyethylene with low molecular weight compounds can be used by adding in the melt to initiate grafting—coupling reactions forming graft or block co-polymers during processing.

Master Batch Production

PAA450-MAH-g-PP pellets were dehydrated in convection drying oven at 80° C. for 3 h and subsequently compounded with PP to produce a concentrated master batch (a reference Master batch). The reference master batch was dry blended with PP at different ratios and injected by injection molding to produce specimens for testing.

In a similar fashion, master batches of PAA450NaY-MAH-g-PP, PAA450NaZr-MAH-g-PP, PAA450NaMo-MAH-g-PP, PAA450KY-MAH-g-PP, PAA450KZr-MAH-g-PP, PAA450KMo-MAH-g-PP, PAA6NaY-MAH-g-PP, PAA6NaZr-MAH-g-PP, PAA6NaMo-MAH-g-PP, and others could be prepared.

1. A polymer having one or more functionalities associated with at least one XRF-detectable metal ion, the polymer being grafted with at least one additional polymer.

2. The polymer according to claim 1, wherein the polymer is selected from fluoropolymers, phenolic resins, polyanhydrides, polyketones, polyesters, polyolefins, vinyl polymers, acrylics, polybenzimidazole, polycarbonate, polystyrene and polyvinyl chloride.

3. The polymer according to claim 1, wherein the polymer is selected from polystyrenes; polycarbonates; polyamides; polyacrylates; polyurethanes; and epoxy polymers.

4. The polymer according to claim 1, wherein the one or more functionality is an acrylate.

5. The polymer according to claim 1, wherein the one or more functionality is selected from an amine, a hydroxyl, a carboxylic acid and a thiol.

6. The polymer according to claim 1, wherein the metal ion is selected from Na, K, Ba, Ca, Mg, Ni, Al, Cr, Co, Cu, Hf, Fe, Pb, Sn, Zn, Ti, Zr, Y, Se, Nb, Sr, Mn, Mo, V Bi and La.

7. The polymer according to claim 1, wherein the at least one additional polymer is selected from thermoplastic polymers, elastomers, polyolefines, plastics, and rubber.

8. The polymer according to claim 1, wherein the at least one additional polymer is selected from polyethylene glycol, polyethylene, polypropylene, acrylonitrile butadiene styrene (ABS), polystyrene, high impact polystyrene, polycarbonate and rubber.

9. The polymer according to claim 1, selected from maleic anhydride grafted polypropylene (-MAH-g-PP) polymers.

10. The polymer according to claim 1, selected from PAA450NaY-MAH-g-PP, PAA450Ner-MAH-g-PP, PAA450NaMo-MAH-g-PP, PAA450KY-MAH-g-PP, PAA450KZr-MAH-g-PP, PAA450KMo-MAH-g-PP, PAA6NaY-MAH-g-PP, PAA6Na7r-MAH-g-PP and PAA6NaMo-MAH-g-PP.

11. A composition comprising a polymer according to claim 1.

12. The composition according to claim 11, being a master batch.

13. The composition according to claim 11, being in a form of a pellet.

14. A composite comprising a polymer according to claim 1.

15. A method of marking an object to be authenticated, the method comprising forming a film or a mark on at least a region of said object, said mark being in the form of a composite according to claim 14.

16. A method of authenticating an object having been marked with a composite material according to claim 14, the method comprising directing a primary electromagnetic signal to the material and detecting and analyzing a (secondary) response signal from the material.

17. The method according to claim 16, the method comprising directing an X-ray signal in the direction of the material and measuring an X-ray response signal.

18. An object comprising a polymer according to claim 1.

19. The object according to claim 18, wherein the object is a packaging material, a textile, an electronic object, an ink composition, a master batch or a rubber-based product.

20. A packaging material comprising a polymer according to claim 1.

21. (canceled)
